(19) United States
(12) Patent Application Publication
(10) Pub. No.: US 2011/0258228 A1
(43) Pub. Date: Oct. 20, 2011

(54) INFORMATION OUTPUT SYSTEM, COMMUNICATION TERMINAL, INFORMATION OUTPUT METHOD AND COMPUTER PRODUCT

(75) Inventor: Koichiro Uchiyama, Saitama (JP)

(73) Assignee: PIONEER CORPORATION, KANAGAWA (JP)

(21) Appl. No.: 13/141,990

(22) PCT Filed: Dec. 26, 2008
(86) PCT No.: PCT/JP2008/073845

§ 371 Date: Jul. 1, 2011

(51) Int. Cl. G06F 17/30

(52) U.S. Cl. 707/770; 707/803; 707/E17.032; 707/E17.101

(57) ABSTRACT

An information providing system (100) comprises an information providing device (110) and a communication terminal (120). The communication terminal (120) extracts a phrase included in the speech of a user and transmits information on the phrase and information on the position of the own device to the information providing device (110). The information providing device (110) searches a wide area network (130) for information on the periphery of the position of the communication terminal (120) on the basis of the position information and the phrase information and transmits the searched information to the communication terminal (120). The communication terminal (120) outputs the information transmitted from the information providing device (110).

### TECHNICAL FIELD

The present invention relates to an information providing apparatus, an information providing system, an information providing method, an information providing program, and a recording medium that provide information to be output at a communication terminal. Further, the present invention is related to the communication terminal, an information output method, an information output program, and a recording medium that output the information provided by the information providing apparatus. However, use of the present invention is not limited to the above information providing apparatus, communication terminal, information providing system, information providing method, information output method, information providing program, information output program, and recording media.

### BACKGROUND ART

Among navigation apparatuses onboard mobile objects such as vehicles, technology that uses a wireless network to collect information on a wide area network (e.g., the Internet) is conventionally known. With such navigation apparatuses, for example, when a facility displayed on a navigation-use map is selected, a wireless communication unit is controlled to access a network, information related to the facility is acquired from a server apparatus, and the acquired information is displayed on a display (for example, refer to Patent Document 1 below).

Patent Document 1: Japanese Laid-Open Patent Publication No. 2006-106442

### DISCLOSURE OF INVENTION

### Problem to be Solved by the Invention

However, with the conventional technology above a problem arises in that, for example, if information suddenly becomes necessary while the vehicle in motion, the information cannot be obtained. In particular, if the response to input or an operation requesting information is slow, there is a high possibility that the information cannot be obtained at the necessary timing. Further, a problem arises in that, for example, the contents of the obtained information are not necessarily that required by the user and thus, there may be occasions when the information is useless.

Furthermore, navigation apparatuses of such technology are used on mobile objects such as vehicles and therefore, connection to the wireless network may be lost while in motion. Consequently, a problem arises in that, for example, the acquisition of information is difficult to perform on a constant basis. A further problem arises in that since attention must be paid to safety during vehicular operation, even if information is displayed on the display, there may be occasions when it is difficult to view the information.

### MEANS FOR SOLVING PROBLEM

To solve the above problems and achieve an object, an information providing apparatus according to the invention according to claim 1 provides information to be output at a communication terminal, and includes a receiving unit that receives position information of the communication terminal and expression-related information related to an expression included in speech of a user of the communication terminal; a searching unit that, based on the position information and the expression-related information received by the receiving unit, searches a wide area network for vicinity-related information related to a vicinity of the communication terminal; and a transmitting unit that transmits to the communication terminal, the vicinity-related information retrieved by the searching unit.

A communication terminal according to the invention of claim 3 outputs information provided from an information providing apparatus, and includes an extracting unit that extracts an expression included in speech of a user; a transmitting unit that transmits to the information providing apparatus, information related to the expression extracted by the extracting unit and position information of the communication terminal; a receiving unit that receives from the information providing apparatus, vicinity-related information related to a vicinity of the communication terminal; and an output unit that outputs the vicinity-related information received by the receiving unit.

An information providing system according to the invention of claim 7 outputs at a communication terminal, information provided from an information providing apparatus. The information providing apparatus includes a receiving unit that receives position information of the communication terminal and expression-related information related to an expression included in speech of a user of the communication terminal, a searching unit that, based on the position information and the expression-related information received by the receiving unit, searches a wide area network for vicinity-related information related to a vicinity of the communication terminal, and a transmitting unit that transmits to the communication terminal, the vicinity-related information retrieved by the searching unit. The communication terminal includes an extracting unit that extracts an expression included in the speech of the user, a transmitting unit that transmits to the information providing apparatus, information related to the expression extracted by the extracting unit and the position information of the communication terminal, a receiving unit that receives from the information providing apparatus, information related to a vicinity of the communication terminal, and an output unit that outputs the vicinity-related information received by the receiving unit.

Further, an information providing method according to the invention of claim 8 is a method of providing information to be output at a communication terminal, and includes receiving position information of the communication terminal and expression-related information related to an expression included in speech of a user of the communication terminal; searching a wide area network for vicinity-related information related to a vicinity of the communication terminal, based on the position information and the expression-related information received at the receiving; and transmitting to the communication terminal, the vicinity-related information retrieved at the searching.

An information output method according to the invention of claim 9 is a method of outputting information provided from an information providing apparatus, and includes extracting an expression included in speech of a user; transmitting to the information providing apparatus, information related to the expression extracted at the extracting and position information of the communication terminal; receiving from the information providing apparatus, vicinity-related information related to a vicinity of the communication terminal; and outputting the vicinity-related information received at the receiving.

An information providing program according to the invention of claim 10 causes a computer to execute the information providing method according to claim 8.

An information output program according to the invention of claim 11 causes a computer to execute the information output method according to claim 9.

Furthermore, a recording medium according to the invention of claim 12 stores therein the information providing program according to claim 10 or the information output program according to claim 11.

### BRIEF DESCRIPTION OF DRAWINGS

FIG. 1 is a block diagram of a configuration of an information providing system according to an embodiment;

FIG. 2 is a flowchart of processing for providing information by an information providing apparatus;

FIG. 3 is a flowchart of a procedure of information output processing by a communication terminal;

FIG. 4 is a diagram of a system configuration of the information providing system according to an example;

FIG. 5 is a block diagram of a hardware configuration of a portable terminal apparatus;

FIG. 6 is a flowchart of a processing procedure performed by the portable terminal apparatus of the information providing system;

FIG. 7 is a diagram depicting an example of a special expression database;

FIG. 8 is a diagram for explaining the processing depicted in FIG. 6;

FIG. 9 is a flowchart of a processing procedure of an information providing server in the information providing system; and

FIG. 10 is a flowchart of another processing procedure of the portable terminal apparatus in the information providing system.

### EXPLANATIONS OF LETTERS OR NUMERALS

100 information providing system
110 information providing apparatus
111 receiving unit
112 searching unit
113 converting unit
114 transmitting unit
120 communication terminal
121 extracting unit
122 transmitting unit
123 receiving unit
124 output unit
130 wide area network

### BEST MODE(S) FOR CARRYING OUT THE INVENTION

With reference to the accompanying drawings, preferred embodiments of an information providing apparatus, a communication terminal, an information providing system, an information providing method, an information output method, an information providing program, an information output program, and a recording medium according to the present invention will be described in detail.

### Embodiment

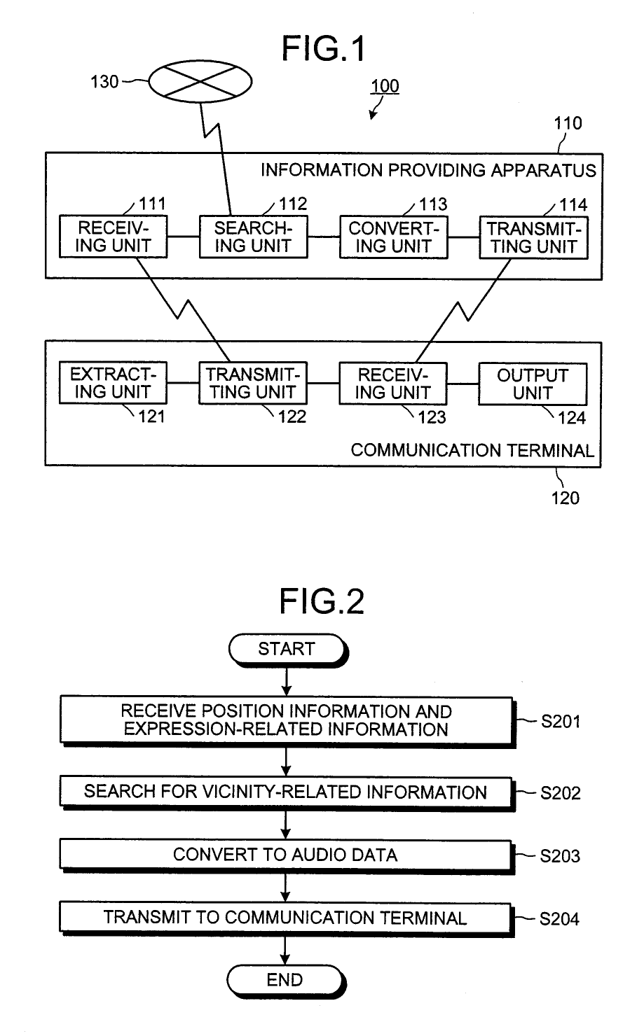

FIG. 1 is a block diagram of a configuration of an information providing system according to the embodiment. An information providing system 100 according to the embodiment includes an information providing apparatus 110 and a communication terminal 120, where information provided by the information providing apparatus 110 is output by the communication terminal 120.

The information providing apparatus 110 includes a receiving unit 111, a searching unit 112, a converting unit 113, and a transmitting unit 114. The receiving unit 111 receives position information of the communication terminal 120 and information related to expressions included in the speech of a user(s) of the communication terminal 120. The position information of the communication terminal 120 is, for example, the latitude and longitude for the current position of the communication terminal 120 or address information. If the communication terminal 120 is moving, the receiving unit 111 may receive information indicating the direction and/or speed of the movement. Further, concerning the information related to expressions included in the speech of the user(s), for example, an expression related to a given subject matter is information indicating the contents of the speech of the user(s). Here, a given subject matter is, for example, “meal” and expressions related to this may be “soba noodles”, “I'm hungry”, etc.

The searching unit 112, based on the position information and the expression-related information received by the receiving unit 111, searches a wide area network 130 for information related to the vicinity where the communication terminal 120 is positioned. For example, if information indicating the content of the speech to be expressions related to meals is received as the expression-related information, the searching unit 112 searches for eating establishments in the vicinity of the communication terminal 120. The vicinity of the communication terminal 120, in addition to the position indicated by the position information received by the receiving unit 111, may be a position estimated after a given period if the communication terminal 120 is moving.

The converting unit 113 converts into audio data, the vicinity-related information retrieved by searching unit 112. The transmitting unit 114 transmits to the communication terminal 120, the vicinity-related information retrieved by the searching unit 112. More particularly, the transmitting unit 114 transmits to the communication terminal 120, the audio data converted by the converting unit 113.

The communication terminal 120 includes an extracting unit 121, a transmitting unit 122, a receiving unit 123, and an output unit 124. The extracting unit 121 extracts expressions included in the speech of the user(s). The extracting unit 121, for example, constantly monitors the speech of the user(s) and determines whether an expression related to a given subject matter is included in the speech of the user(s). The transmitting unit 122 transmits to the information providing apparatus 110, expression-related information extracted by the extracting unit 121 and position information of the communication terminal 120. For example, if the extracting unit 121 determines that an expression related to a given subject matter is included in the speech of the user(s), the transmitting unit 122 transmits the information to the information providing apparatus 110; and the receiving unit 123 receives from the information providing apparatus 110, information related to the vicinity where the communication terminal 120 is positioned.

The output unit 124 outputs the vicinity-related information received by the receiving unit 123. The output unit 124, for example, audibly outputs the vicinity-related information converted into audio data by the converting unit 113 of the information providing apparatus 110. Further, if a particular expression in the speech of the user(s) is extracted by the extracting unit 121, the output unit 124 may output information related to the position. Specifically, for example, the output unit 124 outputs information at the timing of an expression (e.g., “decided”, “determined”, etc.) indicating that a given subject matter in the speech of the user(s) has been decided.

Next, an information providing procedure performed at the information providing system 100 will be described. FIG. 2 is a flowchart of processing for providing information by the information providing apparatus. As depicted in the flowchart of FIG. 2, the information providing apparatus 110, firstly, receives from the communication terminal 120, position information and expression-related information (step S201). Next, based on the position information and the expression-related information received at step S201, vicinity-related information for the communication terminal 120 is searched for by the searching unit 112 (step S202). Subsequently, the information retrieved at step S202 is converted into audio data by the converting unit 113 (step S203). Lastly, the audio data converted at step S203 is transmitted to the communication terminal 120 (step S204), ending the processing according to the flowchart.

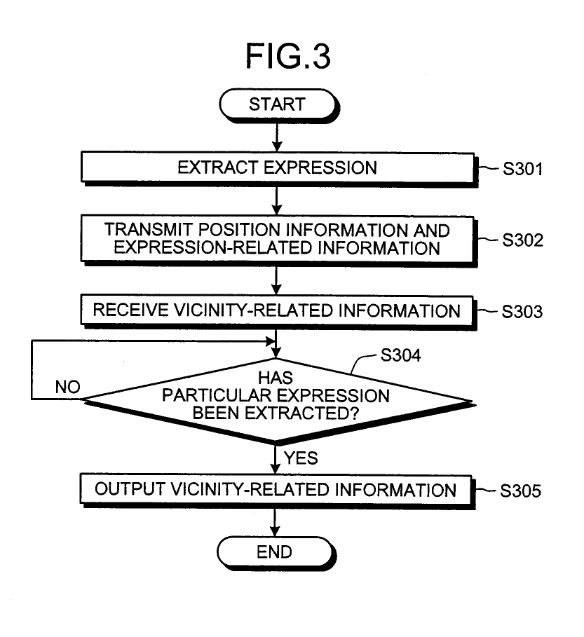

FIG. 3 is a flowchart of a procedure of information output processing by the communication terminal. As depicted in the flowchart of FIG. 3, the communication terminal 120 uses the extracting unit 121 to extract an expression included in the speech of the user(s) (step S301). Next, the expression-related information extracted at step S301 and position information of the communication terminal 120 are transmitted to the information providing apparatus 110 by the transmitting unit 122 (step S302). The communication terminal 120 uses the receiving unit 123 to receive from the information providing apparatus 110, information related to the vicinity where the communication terminal 120 is positioned (step S303).

Subsequently, the communication terminal 120 waits until a particular expression in the speech of the user(s) is extracted by the extracting unit 121 (step S304: NO). When a particular expression is extracted (step S304: YES), the vicinity-related information of the communication terminal 120 is output by the output unit 124 (step S305), ending the processing according to the flowchart.

In the description above, although the converting unit 113 is disposed in the information providing apparatus 110, configuration is not limited thereto and a converting unit may be disposed in the communication terminal 120. In this case, the information providing apparatus 110 transmits the information retrieved by the searching unit 112 as is to the communication terminal 120 and the converting unit of the communication terminal 120 converts the information into audio data.

Further, if the communication terminal 120 is onboard a mobile object, the transmitting unit 122 of the communication terminal 120 may transmit to the information providing apparatus 110, planned route information concerning the planned route to be traveled by the mobile object. Information concerning the planned route, for example, is position information for distinct points (e.g., a starting point and/or destination point, points where left/right turns are made, etc.) on a route planned to be traveled by the mobile object. In this case, the receiving unit 123 receives from the information providing apparatus 110, information related to a vicinity of the planned route; and when a given point on the planned route is reached by the mobile object, the output unit 124 outputs information related to the vicinity of the given point, from among the information related to the vicinity of the planned route.

As described above, the information providing system 100 automatically searches for information, based on the position and speech of the user(s). Consequently, necessary information can be provided without the user(s) having to perform operations to search for the information.

Further, the information providing system 100 converts the retrieved information into audio data and outputs the audio data, enabling necessary information to be provided without the user(s) having to use his/her eyes or hands. In particular, if the user(s) is operating a vehicle, in terms of safety, it is preferable to not perform operations using the eyes or hands. According to the information providing system 100, information can be safely provided to a user operating, for example, a vehicle.

Further, when a particular expression is uttered, specifically, an expression indicating that a given subject matter has been decided, the information providing system 100 outputs information. Consequently, the frequency that information not necessary to the user(s) is output can be reduced. Furthermore, the information providing system 100 preliminarily acquires information along the travel route and when a given point is reached, outputs the information for the point. As a result, even if communication between the information providing apparatus 110 and the communication terminal 120 cannot be performed, the user(s) can obtain necessary information.

### Example

Hereinafter, an example of the present invention will be described. In the example, an application of the present invention where in the information providing system 100, the information providing apparatus 110 is implemented by an information providing server 410 and the communication terminal 120 is implemented by a mobile, communication-capable, portable terminal apparatus having a position information function 420 (hereinafter, simply “portable terminal apparatus 420”) is described as one example. The portable terminal apparatus, for example, may be a navigation apparatus onboard a vehicle, a portable navigation apparatus removable from a vehicle, a portable personal computer, a cellular telephone, etc.

(Configuration of information providing system)

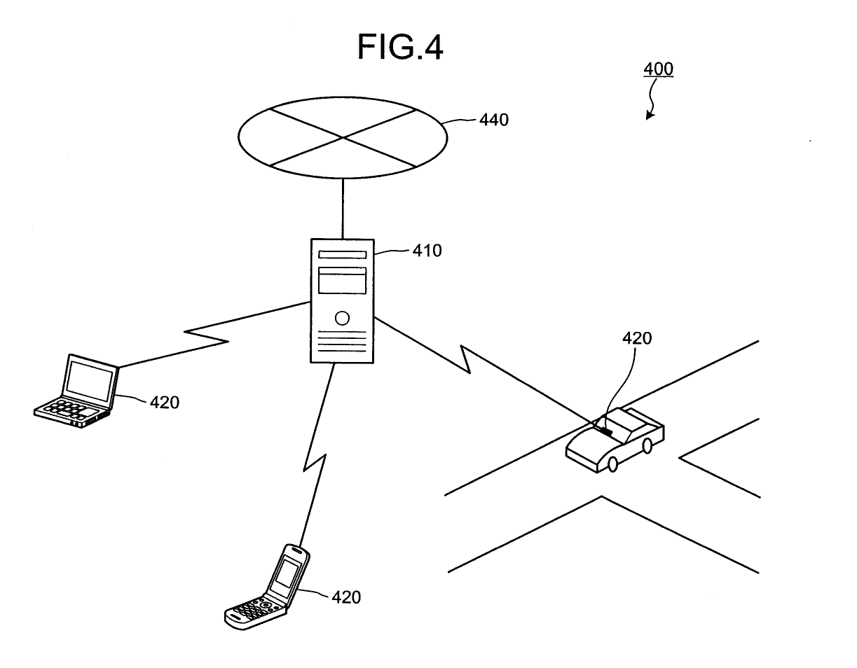

First, a system configuration of the information providing system according to the example will be described. FIG. 4 is a diagram of a system configuration of the information providing system according to the example. As depicted in FIG. 4, an information providing system 400 includes an information providing server 410 as an information providing apparatus and a portable terminal apparatus 420 as a communication terminal. The information providing server 410, in response to a request from the portable terminal apparatus 420, searches for information on a wide area network 440, such as the Internet, and transmits the results to the portable terminal apparatus 420. Further, the portable terminal apparatus 420 outputs the information output from the information providing server 410.

More specifically, in the information providing system 400, the portable terminal apparatus 420, for example, transmits to the information providing server 410, a special expression extracted from the speech of a user(s) and search condition information that includes position information of the portable terminal apparatus 420. The information providing server 410, based on the search condition information, searches the wide area network 440 for information required by the user(s) and after conversion into audio data, transmits the retrieved information to the portable terminal apparatus 420. The information transmitted from the information providing server 410 is provided to the user(s) by the portable terminal apparatus 420 at the stage when truly necessary. By successively performing such processes, information required by the user(s) can be promptly and safely provided.

(Hardware configuration of portable terminal apparatus 420 and information providing server 410)

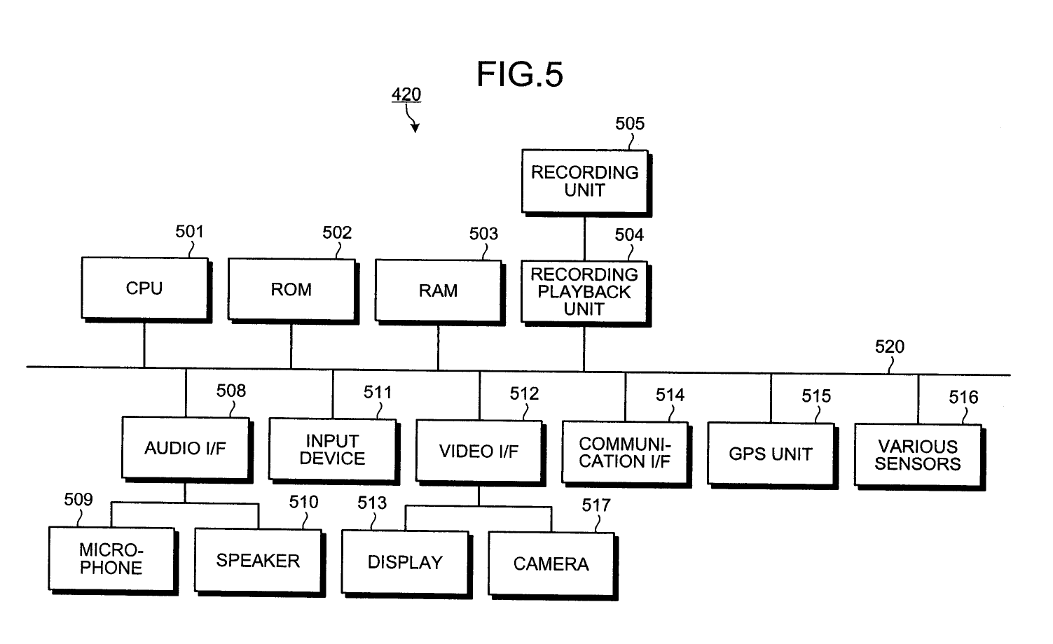

Next, a hardware configuration of the portable terminal apparatus 420 and the information providing server 410 will be described. FIG. 5 is a block diagram of a hardware configuration of the portable terminal apparatus 420. As depicted in FIG. 5, the portable terminal apparatus 420 includes a CPU 501, ROM 502, RAM 503, a recording playback unit 504, a recording unit 505, an audio interface (I/F) 508, a microphone 509, a speaker 510, an input device 511, a video I/F 512, a display 513, a communication I/F 514, a GPS unit 515, various sensors 516, and a camera 517, respectively connected by a bus 520.

The CPU 501 governs overall control of the portable terminal apparatus 420. The ROM 502 stores therein various types of programs such as a boot program and data updating program. Further, the RAM 503 is used as a work are of the CPU 501. In other words, the CPU 501 governs overall control of the portable terminal apparatus 420 by executing various programs stored to the ROM 502, while using the RAM 503 as a work area.

The recording playback unit 504, under the control of the CPU 501, controls the reading and writing of data with respect to the recording unit 505. The recording unit 505 stores data written thereto under the control of the recording playback unit 504. As the recording playback unit, a magnetic/optical disk drive can be used and as the recording unit, for example, a hard disk (HD), flexible disk (FD), MO, solid state disk (SSD), memory card, flash memory, etc. can be used.

Content data and map data may be given as an example of information stored in the recording unit. Content data is, for example, music data, still image data, moving image data, etc. Map data includes background data indicating terrestrial objects (features) such as buildings, rivers, and land surfaces, as well as road-shape data indicating the shapes of roads. Furthermore, the map data is organized in data files according to region.

The audio I/F 508 is connected to the microphone 509 for audio input and to the speaker 510 for audio output. Sounds received by the microphone 509 are A/D converted in the audio I/F 508. The microphone 509, for example, is disposed in a vicinity of a sun visor of the vehicle, and may be singular or plural. Sound derived by D/A converting a given audio signal in the audio I/F 508 is output from the speaker 510.

The input device 511 may be, for example, a remote controller, a keyboard, a touch panel, and the like having keys used to input characters, numerical values, or various kinds of instructions. Further, the input device 511 may be implemented by any one, or more, of the remote controller, the keyboard, and the touch panel.

The video I/F 512 is connected to the display 513. The video I/F 512, specifically, for example, is made up of, for example, a graphic controller that controls the display 513, a buffer memory such as VRAM (Video RAM) that temporarily stores immediately displayable image information, and a control IC that controls the display 513 based on image data output from the graphic controller.

The display 513 displays icons, a cursor, menus, windows, or various data such as text and images. The map data above may be drawn on the display 513 two-dimensionally or 3-dimensionally. A CRT, TFT liquid crystal display, a plasma display, etc., may be employed as the display 513, for example.

The communication I/F 514 is wirelessly connected to a network and functions as an interface of the portable terminal apparatus 420 and the CPU 501. The communication I/F 514 is further connected wirelessly to a communications network such as the Internet and further functions as an interface of the communications network and the CPU 501.

The GPS unit 515 receives signals from GPS satellites and outputs information indicating the current position of the portable terminal apparatus 420. Information output by the GPS unit 515 is used by the CPU 501 to calculate the current position of the portable terminal apparatus 420. Information indicating the current position, for example, is information specifying 1 point such as latitude, longitude, and altitude.

The various sensors 516, such as a vehicular speed sensor, an acceleration sensor, and an angular speed sensor output information used to determine the position and behavior of the vehicle. Values output from the various sensors 516 are used by the CPU 501 to compute the current position and measure changes in speed, direction, etc.

The camera 517 captures images around the portable terminal apparatus 420. The images captured by the camera 517 may be still or moving images. For example, the behavior of the user(s) is captured by the camera 517 and the captured images are output to via the video I/F 512 to a recording medium of the recording unit 505.

Further, information providing server 410 may include the CPU 501, the ROM 502, the RAM 503, the recording playback unit 504, the recording unit 505, the audio I/F (interface) 508, and the communication I/F 514 among the components depicted in FIG. 5.

Concerning the components of the information providing apparatus 110 and the communication terminal 120 depicted in FIG. 1, using programs and data stored on the ROM 502, the RAM 503, the recording unit 505, etc. depicted in FIG. 5, the CPU 501 executes a given program, controls each of the components, whereby the function thereof is implemented.

(Processing for providing information by information providing system)

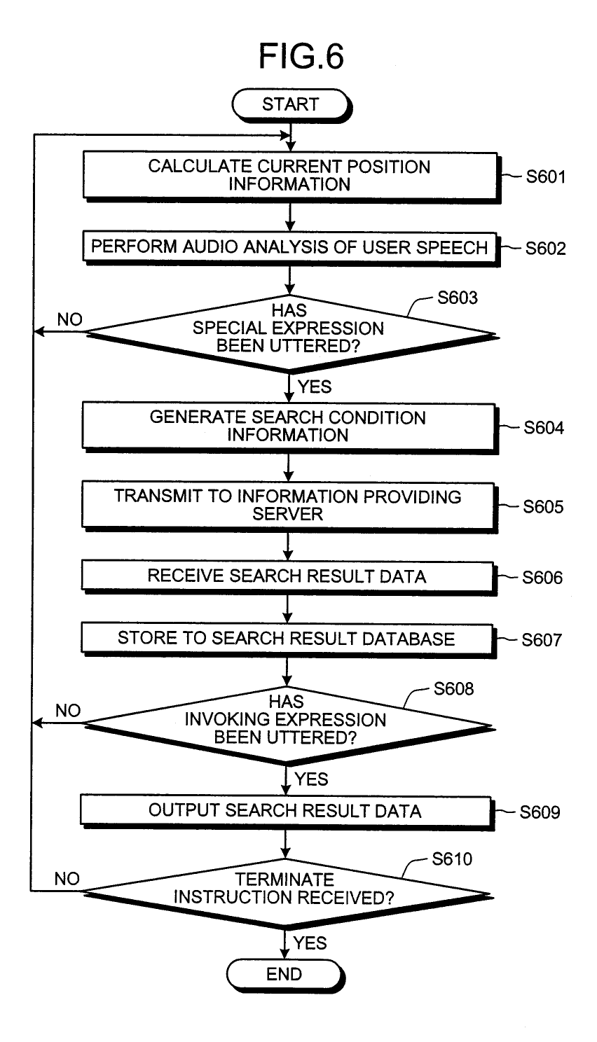

Processing for providing information by the information providing system 400 will be described. FIG. 6 is a flowchart of a processing procedure performed by the portable terminal apparatus of the information providing system. As depicted in the flowchart of FIG. 6, the portable terminal apparatus 420 uses the information obtained by the GPS unit 515 and the various sensors 516 to calculate current position information of the portable terminal apparatus 420 (step S601). Further, the portable terminal apparatus 420 audio analyzes the speech of the user(s) input to the microphone 509 (step S602), and determines whether a special expression has been uttered (step S603). Here, a special expression is an expression related to a given subject matter (e.g., meal, etc.). The portable terminal apparatus 420 has a database of special expressions (special expression database) and determines whether the speech of the user(s) includes an expression in the special expression database.

The portable terminal apparatus 420 returns to step S601 and repeats the processes therefrom until a special expression is uttered (step S603: NO). When a special expression is uttered (step S603: YES), the portable terminal apparatus 420 generates search condition information, based on the special expression (step S604) and transmits the search condition information to the information providing server 410 (step S605). The search condition information includes at least position information of the portable terminal apparatus 420 and the special expression (or a keyword(s) related to the special expression).

The information providing server 410, based on the search condition information transmitted from the portable terminal apparatus 420, searches the wide area network 440 for necessary information and after converting the search results into audio data, transmits the search result data to the portable terminal apparatus 420. The portable terminal apparatus 420 receives the search result data from the information providing server 410 (step S606), and stores the received search result data to a search result database (step S607).

Subsequently, the portable terminal apparatus 420 determines whether an invoking expression has been uttered (step S608). An invoking expression is an expression such as “decided”, “determined”, etc. indicating that the contents of the conversation thus far have been decided. If an invoking expression has been uttered (step S608: YES), the portable terminal apparatus 420 outputs the search result data in the search result database (step S609). The search result data has been converted into audio data and therefore, the portable terminal apparatus 420 outputs the search result data from the speaker 510 as sound. On the other hand, if an invoking expression has not been uttered (step S608: NO), without outputting the search result data, the portable terminal apparatus 420 returns to step S601 and repeats the processes therefrom.

Until a terminate instruction for the output of information is received (step S610: NO), the portable terminal apparatus 420 returns to step S601 and repeats the processes therefrom. When a terminate instruction for the output of information is received (step S610: YES), the portable terminal apparatus 420 ends the processing according to the flowchart.

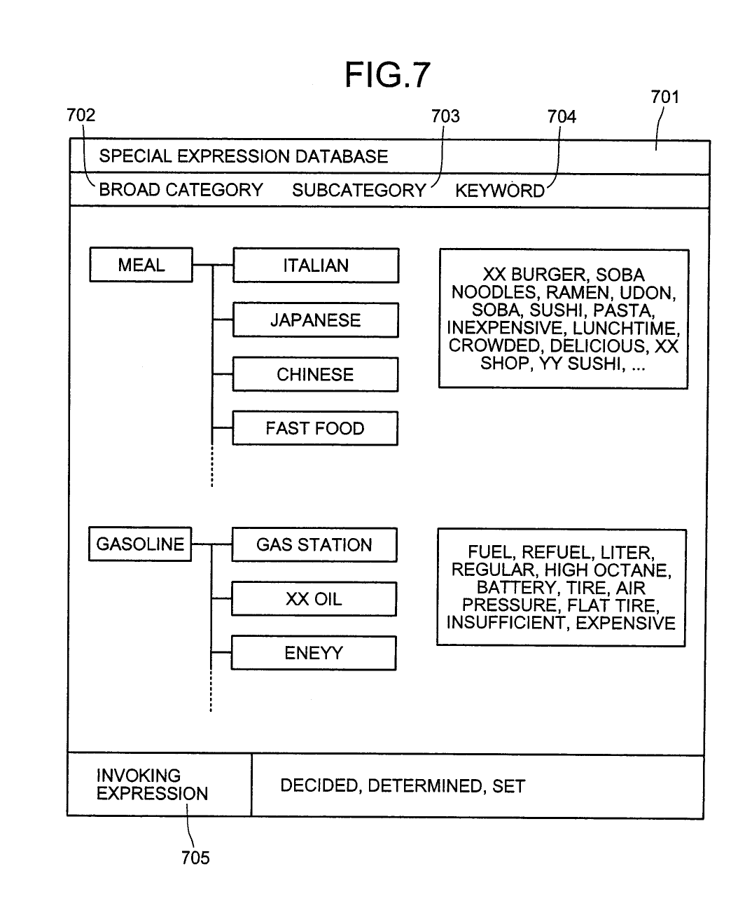

FIG. 7 is a diagram depicting an example of the special expression database. Expressions in a special expression database 701 depicted in FIG. 7 are classified into broad category expressions 702, subcategory expressions 703, and related keywords 804. In the example depicted in FIG. 7, “meal” and “gasoline” are registered as examples of broad category expressions 702. Further, “Italian”, “Japanese”, etc. are registered subcategory expressions 703 correlated to the broad category expression 702 “meal”. Moreover, expressions such as “XX Hamburger”, “soba noodles”, etc. are registered as related keywords. Invoking expressions 705 are further registered in the special expression database 701 depicted in FIG. 7. In FIG. 7, “decided”, “determined”, etc. are registered as invoking expressions.

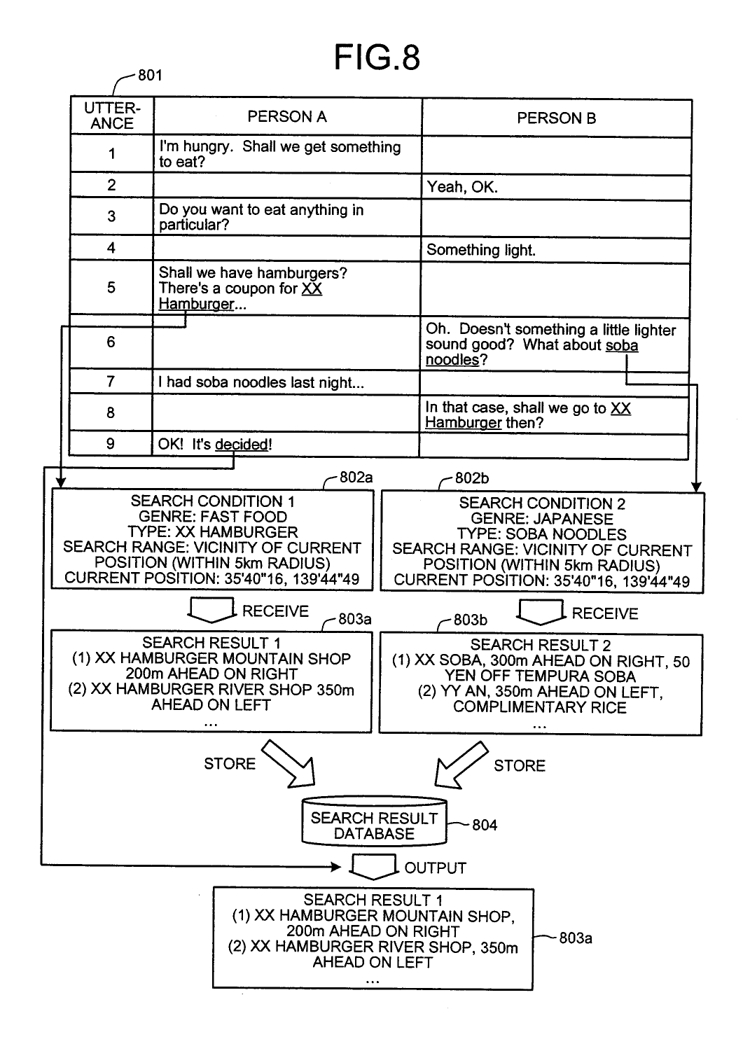

FIG. 8 is a diagram for explaining the processing depicted in FIG. 6. A table 801 in FIG. 8 depicts a conversation between person A and person B, about meals. In FIG. 8, underlined expressions “XX Hamburger” and “soba noodles” are registered in the special expression database. When the special expression “XX Hamburger” in utterance 5 is uttered by person A, the portable terminal apparatus 420 generates and transmits to the information providing server 410, search condition 1 (802a) for searching for a “XX Hamburger” that is in the vicinity of the portable terminal apparatus 420. The information providing server 410 uses the search condition 1 (802a) to search information on the wide area network 440 and transmits search results 1 (803a) to the portable terminal apparatus 420. The portable terminal apparatus 420 stores the search results 1 (803a) to the search result database 804 and regards the search results 1 (803a) as an output candidate.

Next, when the special expression “soba noodles” in utterance 6 is uttered by person B, the portable terminal apparatus 420 generates and transmits to the information providing server 410, search condition 2 (802b) for searching for a soba noodle shop in the vicinity of the portable terminal apparatus 420. The information providing server 410 uses the search condition 2 (802b) to search information on the wide area network 440 and transmits search results 2 (803b) to the portable terminal apparatus 420. The portable terminal apparatus 420 stores the search results 2 (803b) to the search result database 804 and regards the search results 2 (803b) as the output candidate in place of the search results 1 (803a).

Although the special expression “XX Hamburger” in utterance 8 is uttered by person B, “XX Hamburger” is an expression that has already been searched for and thus, without generating a search condition, the search results 2 (803b) are replaced by the search results 1 (803a) as the output candidate. When the invoking expression “decided” in utterance 9 is uttered by person A, the current output candidate, search results 1 (803a), is output.

User preferences and interests may be preliminarily analyzed based on, for example, a history of user behavior and when search condition information is generated, search condition information may be generated so as to obtain search results that reflect user preferences and interests. Specifically, for example, if the user(s) uses a particular chain store at a high frequency, the search may be narrowed to the chain store alone or information for the chain store may be placed higher in the search results.

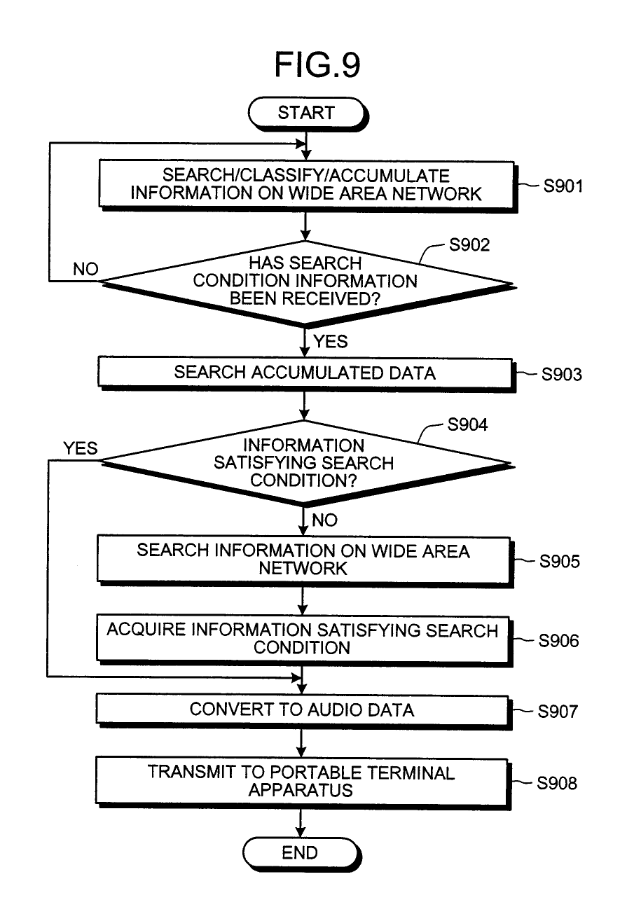

Next, processing by the information providing server 410 will be described. FIG. 9 is a flowchart of a processing procedure of the information providing server in the information providing system. As depicted in the flowchart of FIG. 9, the information providing server 410 preliminarily searches, classifies and accumulates information on the wide area network 440 (step S901), enabling a prompt response to an information request from the portable terminal apparatus 420.

Until search condition information is received from the portable terminal apparatus 420 (step S902: NO), the information providing server 410 returns to step S901 and continues to search/classify/accumulated information on the wide area network 440. When search condition information is received from the portable terminal apparatus 420 (step S902: YES), the information providing server 410 searches the data that has been accumulated (accumulated data) (step S903) and determines whether information satisfying the search condition is present (step S904). If information satisfying the search condition is among the accumulated data (step S904: YES), the information providing server 410 proceeds to step S907. On the other hand, if information satisfying the search condition is not among the accumulated data (step S904: NO), the information providing server 410 searches information on the wide area network 440 (step S905) and acquires information satisfying the search condition (step S906).

The portable terminal apparatus 420 converts the information satisfying the search condition into audio data (step S907), and outputs the audio data to the portable terminal apparatus 420 (step S908), ending the processes according to the flowchart. Through the above processing, the information providing server 410 provides information to the portable terminal apparatus 420.

As described above, the information providing system 400 automatically searches for information, based on the position of the user(s) and expressions included in the speech of the user(s). Consequently, necessary information can be provided without the user(s) having to perform operations to search for the information. Further, the information providing system 400 converts the retrieved information into audio data and outputs the audio data, enabling necessary information to be provided without the user(s) having to use his/her eyes or hands. For example, if the user(s) is operating a vehicle, in terms of safety, it is preferable to not perform operations using the eyes or hands. According to the information providing system 400, information can be safely provided to a user operating, for example, a vehicle.

Further, when an invoking expression is uttered, the information providing system 400 outputs information. Consequently, the frequency that information not necessary to the user(s) is output can be reduced. Furthermore, based on the position of the user(s) and expressions included in the speech of the user(s), the information providing system 400 searches for and acquires necessary information at the time of the utterance. Consequently, when an invoking expression is uttered, since the information has already been acquired, the information can be immediately output for the user(s).

For example, if the traveling route of the vehicle has been determined, information may be preliminarily received from the information providing server 410 and output as necessary, since there may be occasions while the user(s) is moving by vehicle and communication between the portable terminal apparatus 420 and the information providing server 410 cannot be performed and thus, information cannot be transmitted or received.

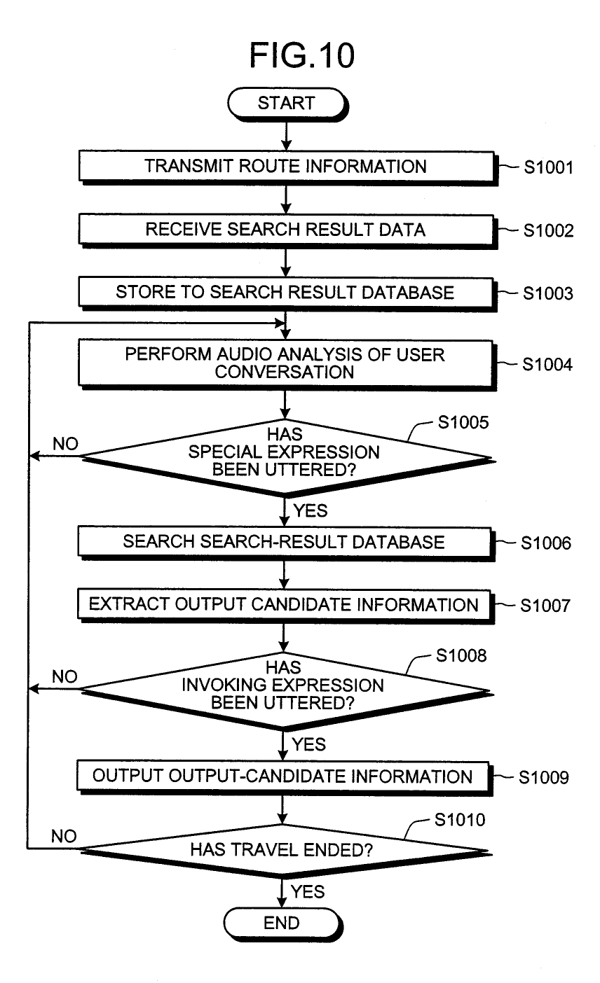

FIG. 10 is a flowchart of another processing procedure of the portable terminal apparatus in the information providing system. FIG. 10 is a flowchart of an example where the portable terminal apparatus 420 is onboard (or installed on) a vehicle. The portable terminal apparatus 420 transmits to the information providing server 410, as search condition information, route information concerning the route traveled by the vehicle (step S1001). Here, the search condition information may include information related to user preferences and interests. Further, the route information may be information for a portion of the entire traveling route (for example, a section in which communication is not expected to be possible). The information providing server 410, based on the search condition information transmitted from the portable terminal apparatus 420, searches the wide area network 440 for information required by the user(s) and after converting the search results into audio data, outputs the audio data to the portable terminal apparatus 420.

Upon receiving the search result data from the information providing server 410 (step S1002), the portable terminal apparatus 420 stores the receive information to the search result database (step S1003). The portable terminal apparatus 420 performs audio analysis on the user conversation input to the microphone 509 (step S1004), and waits until a special expression is uttered (step S1005: NO). When a special expression is uttered (step S1005: YES), the portable terminal apparatus 420 searches the search result database (step S1006) and extracts, as output candidate information, current-position vicinity information related to the special expression (step S1007).

The portable terminal apparatus 420 returns to step S1004 and continues the processes therefrom until an invoking expression is uttered (step S1008: NO). When an invoking expression is uttered (step S1008: YES), the portable terminal apparatus 420 outputs the output candidate information (step S1009). The portable terminal apparatus 420 returns to step S1004 and repeats the processes therefrom until travel by the vehicle ends (step S1010: NO). When travel by the vehicle ends (step S1010: YES), the processes according to this flowchart ends. Even if communication between the portable terminal apparatus 420 and the information providing server 410 cannot be performed, the user(s) can obtain necessary information by processes like those above.

Although retrieved information has been described above to be converted into audio data at the information providing server 410, the conversion may be performed at the portable terminal apparatus 420. Further, audio recognition of user speech has been described above to occur at the portable terminal apparatus 420; however, for example, conversation audio data may be uploaded to the information providing server 410 as is, whereby audio recognition is performed at the information providing server 410.

Further, although analysis results of user speech is described above to be used only for information searches, the analysis results, for example, may be used in the operation of devices such as a content playback apparatus. Specifically, if user speech includes an operation instruction for a device, the portable terminal apparatus 420 generates a control signal to execute the operation instruction and outputs the control signal to the device. Further, the device to be operated may be a device in the home, connected through a network to the portable terminal apparatus 420; a content-on-demand server; etc.

The information providing method and the information output method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the recording medium, and executed by the computer. The program may be a transmission medium that can be distributed through a network such as the Internet.

1-12. (canceled)

13. An information output system that outputs at a communication terminal, information provided from an information providing apparatus, wherein
the information providing apparatus comprises:
a receiving unit that receives position information of the communication terminal and sequentially receives information related to a plurality of search expressions included in random speech of a user of the communication terminal,
a searching unit that, based on the position information and the information related to search expressions included in the random speech, searches a wide area network for vicinity-related information related to a vicinity of the communication terminal, the vicinity-related information being searched for each time a search expression is received,
a converting unit that converts into audio data, the vicinity-related information retrieved each time a search expression is received, and
a transmitting unit that sequentially transmits to the communication terminal, the audio data converted by the converting unit; and
the communication terminal comprises:
an extracting unit that extracts the search expressions included in the random speech of the user,
a transmitting unit that transmits to the information providing apparatus each time the extracting unit extracts a search expression, the position information of the communication terminal and information related to the extracted search expression,
a receiving unit that sequentially receives from the information providing apparatus, the audio data indicative of the vicinity-related information for the communication terminal, retrieved based on the information related to the search expressions,
a storage unit that stores therein the audio data sequentially received by the receiving unit,
a detecting unit that detects a determination expression that is included in the random speech of the user and that is for outputting any one among the audio data stored in the storage unit, and an output unit that if the detecting unit detects a determination expression, outputs from the storage unit, the audio data that is specified based on the timing when the determination expression is uttered and that is indicative of the vicinity-related information for the communication terminal.

14. A communication terminal used in an information output system and comprising:
an extracting unit that extracts search expressions included in random speech of a user;
a transmitting unit that transmits to an information providing apparatus each time the extracting unit extracts a search expression, position information of the communication terminal and information related to the extracted search expression;
a receiving unit that sequentially receives from the information providing apparatus, audio data indicative of vicinity-related information for the communication terminal, retrieved based on the information related to the search expressions;
a storage unit that stores therein the audio data sequentially received by the receiving unit;
a detecting unit that detects a determination expression that is included in the random speech of the user and that is for outputting any one among the audio data stored in the storage unit; and
an output unit that if the detecting unit detects a determination expression, outputs from the storage unit, the audio data that is specified based on the timing when the determination expression is uttered and that is indicative of the vicinity-related information for the communication terminal.

15. An information output method performed by a communication terminal that outputs information provided from an information providing apparatus, the method comprising:
extracting search expressions included in random speech of a user;
a transmitting unit that transmits to the information providing apparatus each time a search expression is extracted at the extracting, position information of the communication terminal and information related to the extracted search expression;
receiving sequentially from the information providing apparatus, audio data indicative of vicinity-related information for the communication terminal, retrieved based on the information related to the search expressions;
storing to a storage unit, the audio data sequentially received at the receiving;
detecting a determination expression that is included in the random speech of the user and that is for outputting any one among the audio data stored in the storage unit; and
outputting from the storage unit, if a determination expression is detected at the detecting, the audio data that is specified based on the timing when the determination expression is uttered and that is indicative of the vicinity-related information for the communication terminal.

16. A computer-readable, recording medium storing therein an information output program that causes a computer to execute the information output method according to claim 15.
